(19) United States
(12) Patent Application Publication
(10) Pub. No.: US 2014/0083884 A1
(43) Pub. Date: Mar. 27, 2014

(54) Chainsaw Bar / Chain Packaging Technique and Packaging Employed for the Same

(71) Applicant: Pamela Everett, Charlotte, NC (US)

(72) Inventor: Pamela Everett, Charlotte, NC (US)

(73) Assignee: HUSQVARNA AB, Huskvarna (SE)

(21) Appl. No.: 14/119,582

(22) PCT Filed: Dec. 15, 2011
(86) PCT No.: PCT/US2011/065064

§ 371 Date: Nov. 22, 2013

(51) Int. Cl. B65D 71/10; B27B 17/02

(52) U.S. Cl. CPC B65D 71/10; B27B 17/02
USPC 206/349; 53/397

(57) ABSTRACT

A chainsaw bar assembly includes a chainsaw bar, a chain and a first packaging material. The chainsaw bar includes a chainsaw body engagement portion configured to engage a body of a chainsaw proximate to a drive member. The chain is provided for operable engagement with the chainsaw bar. The first packaging material is applied at a portion of the chainsaw bar that is forward of the chainsaw body engagement portion. The first packaging material holds the chain affixed to the chainsaw bar to enable engagement of the chain to the drive member of the chainsaw and engagement of the chainsaw bar to the body of the chainsaw without removal of the first packaging material.

### TECHNICAL FIELD

Example embodiments generally relate to chainsaws and, more particularly, relate to a packaging technique and the packaging employed for the same.

### BACKGROUND

Chainsaws are commonly sold in one of various different conditions. First, the chainsaw may be sold completely assembled with the bar already attached, and the chain installed on the bar and properly connected to the clutch. Selling chainsaws in this manner supplies a chainsaw already fully and correctly assembled, but requires additional assembly time and corresponding expense. A second common condition in which chainsaws are sold is with the bar and chain not yet assembled. For example, the bar and chain may be placed in the box or packaging in which the chainsaw is sold separately from each other and the chainsaw body. As yet another alternative, the chain may be placed over the bar, but the entire assembly may be placed into a back or loose fitting packaging container. The buyer may then be expected to install the chain onto the bar, and install the bar and chain combination onto the chainsaw, or at least maintain the chain properly on the bar while installing the bar and chain combination onto the chainsaw.

Installing the bar and chain onto the chainsaw may be a relatively simple task for experienced chainsaw owners. However, for many first time or relatively inexperienced buyers, installation of the bar and chain may be a bit more tricky. For example, it is possible to install the chain backwardly on the bar. Backward installation of the chain will not properly dispose the cutters on the chain toward the lumber to be cut, and thus cutting efficiency could be vastly reduced. Furthermore, even when the chain is correctly oriented on the bar, it may be difficult to install the bar/chain combination onto the chainsaw and properly connect the chain to the clutch. These difficulties and corresponding buyer complaints may lead many manufacturers to take the extra step and costs associated with completing assembly. However, shipping costs may also be increased due to the larger size of the resulting packaging needed for shipment of a fully assembled chainsaw. Moreover, bar/chain replacement may also be just as difficult for chainsaw users to handle themselves. Thus, full assembly may not be a completely satisfying option.

### BRIEF SUMMARY OF SOME EXAMPLES

Some example embodiments may therefore provide a packaged bar and chain assembly and a method of packaging the same. The packaged bar and chain assembly may be provided such that the packaging holds the chain properly installed on the bar. The bar, with chain provided thereon, may then be installed onto the chainsaw without removal of the packaging (or at least a substantial portion of the packaging that is forward of the clutch cover of the chainsaw). Thus, assembly of the chainsaw by a buyer or user of the chainsaw may be made simpler and easier.

In one example embodiment, a chainsaw bar assembly is provided. The chainsaw bar assembly includes a chainsaw bar, a chain and a first packaging material. The chainsaw bar includes a chainsaw body engagement portion configured to engage a body of a chainsaw proximate to a drive member. The chain is provided for operable engagement with the chainsaw bar. The first packaging material is applied at a portion of the chainsaw bar that is forward of the chainsaw body engagement portion. The first packaging material holds the chain affixed to the chainsaw bar to enable engagement of the chain to the drive member of the chainsaw and engagement of the chainsaw bar to the body of the chainsaw without removal of the first packaging material.

In another example embodiment, a method of packaging is provided. The method may include installing a chain onto a chainsaw bar. The chainsaw bar may be separate from a chainsaw body of a chainsaw onto which the chainsaw bar is designed to fit for operation of the chainsaw when the installation of the chain is performed. The method may further include applying a first packaging material at a portion of the chainsaw bar that is forward of a chainsaw body engagement portion of the chainsaw bar. The first packaging material may hold the chain affixed to the chainsaw bar to enable engagement of the chain to a drive member of the chainsaw and may also enable engagement of the chainsaw bar to a body of the chainsaw without removal of the first packaging material.

Some example embodiments may improve the ability of operators to install a chainsaw bar and its chain without complication and thereby improve the operator experience.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a side view of a portion of an example chainsaw that may employ an example embodiment;

FIG. 2 illustrates a side view of a chain and bar assembly according to an example embodiment;

FIG. 3 illustrates a perspective view of a chain saw body engagement portion of the chainsaw bar with two packaging portions applied thereto according to an example embodiment;

FIG. 4 illustrates a side view of the chainsaw with a clutch cover (or drive sprocket cover) removed; and

FIG. 5 illustrates a block diagram of a method according to another example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, assembly of a chainsaw involving the attachment of the chain and bar to the main body of the chainsaw can be complicated for inexperienced operators. The chain itself must be inserted into the groove that extends around the periphery of the bar and must then be attached to the drive member or drive sprocket (e.g., clutch) of the chainsaw while the bar is also attached to the main body of the chainsaw. This assembly process first requires that the chain be oriented properly onto the bar. Then, the chain must be tightly held (typically by one hand of the operator) to the bar while exposing slack in the chain at the end of the bar that engages the main body of the chainsaw. The bar must then be held in a proper orientation while the slack portion in the chain is provided over the drive sprocket (e.g., clutch) of the chainsaw and the bar is installed onto the main body of the chainsaw. Some operators may struggle to maintain the proper alignments and orientations while attempting this assembly.

Some example embodiments may provide a packaging method that provides the chain and bar as a prepackaged assembly that is ready for relatively easy installation onto the main body of the chainsaw without removal of at least a portion of the packaging material. In fact, the portion of the packaging material that is not removed may hold the chain in its proper alignment with the bar and also keep exposed slack in the chain at the portion of the chain that is to be engaged with the drive sprocket.

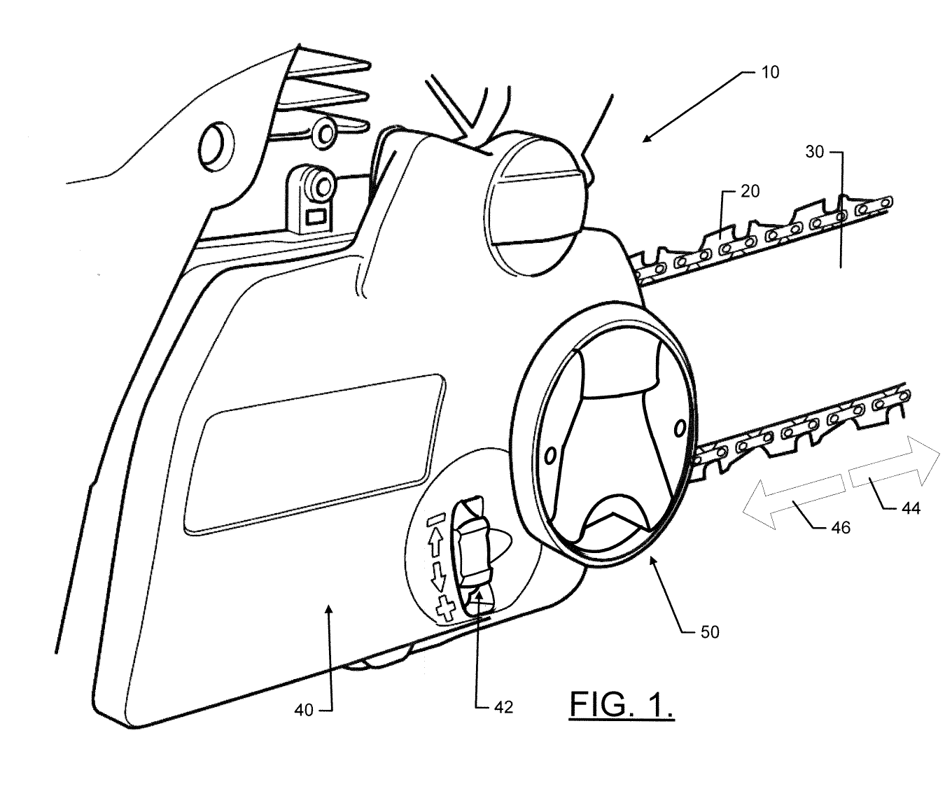

An example embodiment will now be described in connection with the drawings shown in FIGS. 1-4.

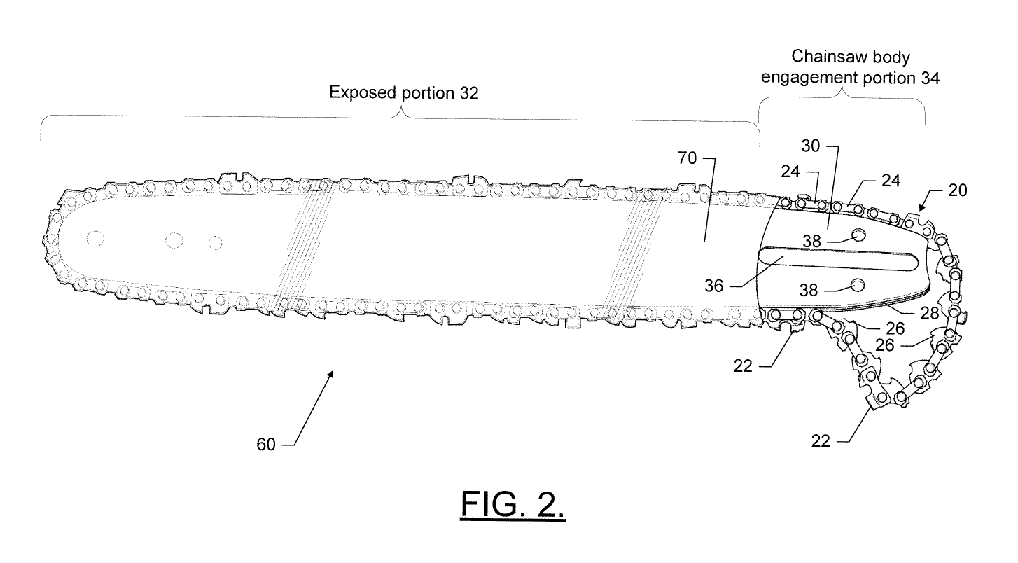

Referring now to FIGS. 1 and 2, a chainsaw 10 is shown fully assembled in order to facilitate a description of some portions of the chainsaw 10 that are applicable to interaction with an example embodiment. However, it should be appreciated that example embodiments may be practiced with respect to a bar and chain assembly 60 (see FIG. 2) and thus, installation of the bar and chain assembly 60 onto the chainsaw 10 is not required in order to practice an example embodiment. Instead, example embodiments relate to packaging that may be employed prior to installation of the bar and chain assembly 60 onto the chainsaw 10. Moreover, the practicing of an example embodiment may be accomplished in a manner that facilitates easy installation of the bar and chain assembly 60 to achieve the full assembly of chainsaw 10 as shown in FIG. 1.

Among other things, the chainsaw 10 may include a drive member or drive sprocket that is rotated responsive to operation of the engine of the chainsaw 10. The drive sprocket may be operably connected to a saw chain 20, which may include cutters 22 disposed on all or some of a series of chain links 24 that are interconnected to form a continuous flexible chain. Some or all of the chain links 24 may include engagement teeth 26 that are configured to fit within and slidably engage a guide slot 28 that extends around a periphery of a bar 30 (e.g., a chain bar or guide bar) that is operably coupled to the chainsaw 10.

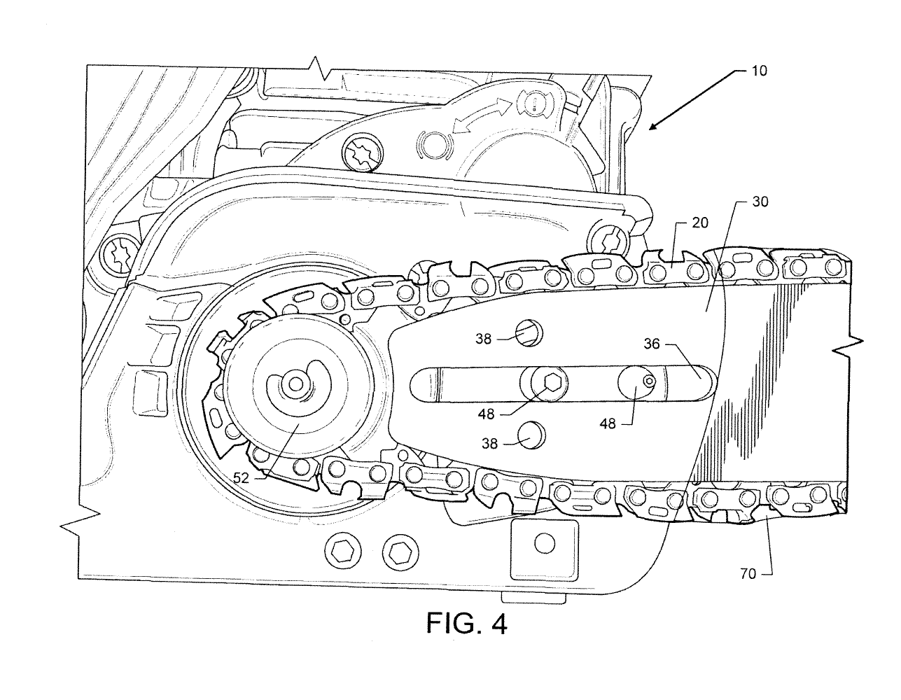

In some embodiments, the drive sprocket (or drive member) may be embodied as a part of a clutch (see clutch 52 in FIG. 4) that is disengaged when the engine idles, but engages to rotate the chain 20 around the bar 30 (e.g., via the engagement teeth sliding through the guide slot 28) when the engine throttle is opened. In chainsaws that are electrically powered, there may be no need for a clutch, since an electric motor may power the drive sprocket and the electric motor need not idle when rotation of the chain is not desired. Thus, instead of including a clutch, the electric motor may be engaged to drive the drive sprocket whenever a trigger or throttle lever is depressed to activate the electric motor and may simply be disengaged at other times.

The bar 30 may be a unitary, substantially flat metallic member that is elongated to form a substantially oblong blade. However, in some embodiments, the bar 30 may not necessarily be unitary, but may include component parts that are combined to form a flat blade with the guide slot 28 extending around peripheral edges thereof. In any case, the bar 30 may include at least two general portions, namely an exposed portion 32 and a chainsaw body engagement portion 34. The exposed portion 32 may include the portion of the bar 30 that exposes cutters 22 for use in cutting lumber. Meanwhile, the chainsaw body engagement portion 34 may be the portion of the bar 30 that is hidden by a drive sprocket cover or a clutch cover 40 (see FIG. 1) of the chainsaw 10 when the bar 30 and chain 20 are operably coupled to a main body portion of the chainsaw 10. In some embodiments, the chainsaw body engagement portion 34 may further include a slot 36 disposed to extent substantially along a longitudinal centerline of the chainsaw body engagement portion 34. The slot 36 may provide a variable engagement position between the main body portion of the chainsaw 10 and the bar 30. In this regard, one or more tensioner engagement orifices 38 may be disposed proximate to the slot 36 so that one or more pins may engage the tensioner engagement orifices 38 to enable the position of the bar 30 to be changed to adjust the tension of the chain 20.

The drive sprocket may be hidden from view on the chainsaw 10 by the drive sprocket cover 40 (or clutch cover in embodiments where the drive sprocket is embodied as a clutch). The drive sprocket cover 40 may cover over the chainsaw body engagement portion 34 of the bar 30. In other words, the drive sprocket cover may cover over all portions of the bar 30 other than the exposed portion 32. In an example embodiment, the exposed portion 32 may be considered to be the portion of the bar 30 that is forward of the drive sprocket cover 40 or not covered by the drive sprocket cover 40 when the bar 30 is installed on the chainsaw 10 and the drive sprocket cover 40 is also installed.

In some embodiments, the drive sprocket cover 40 may include a chain tensioner 42 disposed thereon to enable the bar to be shifted forward (as shown by arrow 44) or backward (as shown by arrow 46) to adjust the tension of the chain 20 on the bar 30. The bar 30 may be disposed proximate to a main body portion of the chainsaw 10 such that the chainsaw body engagement portion 34 is proximate to the chainsaw 10 while the exposed portion 32 extends away from the chainsaw 10. The main body portion of the chainsaw 10 may include one or more guide posts 48 extending therefrom parallel to each other. The guide posts 48 may be aligned to enable the slot 36 to be fitted over the guide posts 48 as shown in FIG. 4. One or more pins that are operably coupled to the chain tensioner 42 may then engage one or more of the tensioner engagement orifices 38 when the drive sprocket cover 40 is installed as shown in FIG. 1. Movement of the chain tensioner 42 in one direction may cause the one or more pins to move forward or rearward to shift the bar 30 forward or backward as shown by arrows 44 and 46, respectively. Movement of the chain tensioner 42 in the other direction, may cause movement of the bar 30 in the opposite direction. The drive sprocket cover 40 may also include a cover removal knob 50 that may be tightened to affix the drive sprocket cover 40 to the main body portion of the chainsaw 10, or may be loosened to enable the drive sprocket cover 40 to be removed (e.g., to expose the view provided in FIG. 4).

FIG. 4 shows a side view of the chainsaw 10 with the drive sprocket cover 40 removed. FIG. 4 further shows an example drive member or drive sprocket (e.g., clutch 52) properly engaged to sprocket teeth (not shown in FIG. 4) with the chain 20 while the bar 30 is attached to the guide posts 48. As indicated above, when the chain 20 and the bar 30 are not already assembled, some operators may struggle to achieve the arrangement shown in FIG. 4. In this regard, installation of the chain 20 and bar 30 may typically require that the operator hold the chain 20 to the bar 30 tightly so that the engagement teeth 26 are substantially engaged with the guide slot 28 leaving a portion of slack chain at a rear portion of the bar 30 (e.g., at an end of the chainsaw body engagement portion 34). The slack chain may then need to be routed around the clutch 52 while the guide posts 48 are fed through the slot 36. However, some operators may struggle to achieve these alignments simultaneously. In this regard, while trying to achieve the routing of the slack in the chain 20 around the clutch 52 while simultaneously feeding the guide posts 48 through the slot 36, the operator may have a difficult time holding the engagement teeth 26 in the guide slot 28.

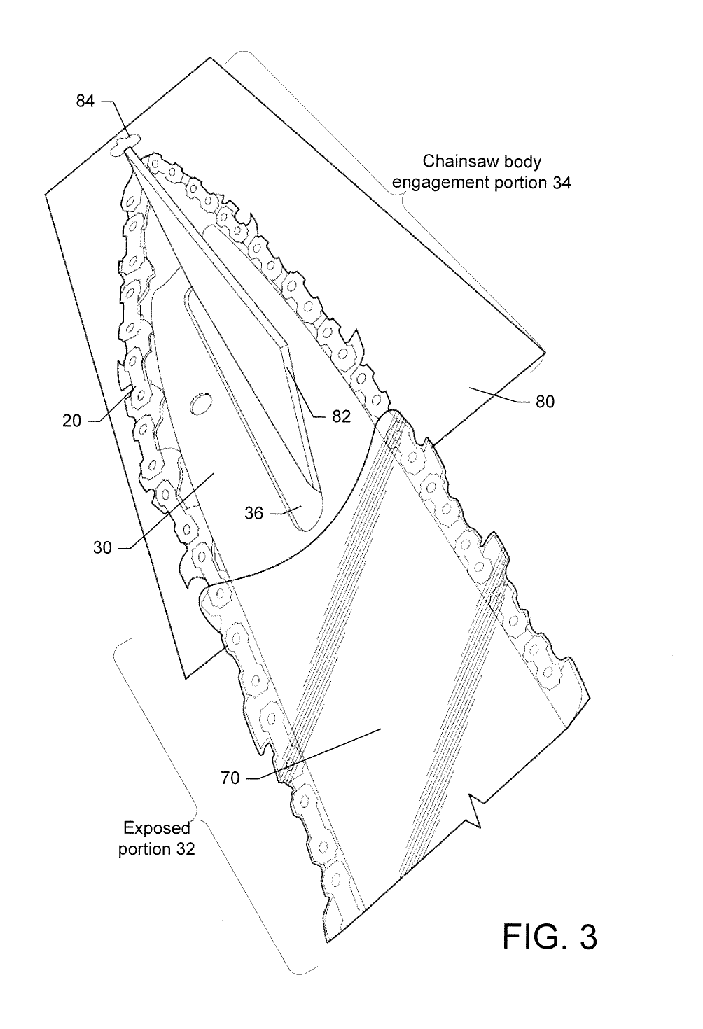

Example embodiments may eliminate the complication involved in performing these alignments simultaneously by removing the need for the operator to hold the chain 20 to the bar 30. In this regard, an example embodiment may provide for a bar and chain assembly 60 in which the chain 20 is held to the bar 30 by packaging materials that leaves exposed at least the portions of the bar 30 and chain 20 that need to be exposed to facilitate engagement with the drive sprocket (e.g., clutch 52 in FIG. 4) and the main body portion of the chainsaw 10 (e.g., via the guide posts 48 engaging the slot 36). FIG. 2 illustrates the bar and chain assembly 60, while FIG. 3 illustrates the bar and chain assembly 60 with an optional additional packaging portion provided therewith. FIG. 4 shows the bar and chain assembly 60 installed on the chainsaw 10.

As shown in FIG. 2, the bar and chain assembly 60 includes the bar 30, the chain 20 and a first packaging material 70 that is applied at a portion of the bar 30 that is forward of a chainsaw body engagement portion 34. The first packaging material 70 of this example embodiment is disposed around an entirety of the exposed portion 32 of the bar 30. However, in some other embodiments, the first packaging material 70 may be disposed around only a substantial portion of the exposed portion 32, or around a portion of the exposed portion 32 that is adjacent to the chainsaw body engagement portion 34. In any case, the first packaging material 70 may be configured to tightly fit over the bar 30 and chain 20 such that the chain 20 is held affixed to the bar 30 in a relatively tight arrangement. In other words, the first packaging material 70 may be disposed over the exposed portion 32 of the bar 30 and portions of the chain 20 that are proximate thereto to hold the engagement teeth 26 in the guide slot 28.

In some embodiments, the first packaging material 70 may be a plastic material that may be relatively tightly wrapped around the chain 20 and the bar 30 at the exposed portion 32. However, in some alternative embodiments, the first packaging material 70 may further be a shrink-wrap material such as polyolefin, PVC or another composition that may be heated to constrict the material for shrinkage to tightly fit around the bar 30 and chain 20 to form the bar and chain assembly 60. In yet other embodiments, a plastic, vinyl, or other material may be formed into a rigid cover that can be slid over the bar 30 and chain 20 with a relatively tight tolerance in order to hold the chain 20 to the bar 30 (at least at the exposed portion 32 thereof) to enable the operator to concentrate only on engaging the slack portion of the chain 20 to the drive socket while affixing the bar 30 to the guide posts 48. Although the first packaging material 70 of FIGS. 2-4 is shown as a transparent material, it is not necessary that the first packaging material 70 be transparent.

As indicated above, the first packaging material 70 may be configured to tightly fit over the bar 30 and chain 20 such that the chain 20 is held affixed to the bar 30 in a relatively tight arrangement. Moreover, the first packaging material may be disposed to hold the chain 20 affixed to the bar 30 to enable engagement of the chain 20 to a drive sprocket (e.g., clutch 52) of the chainsaw 10 and enable engagement of the bar 30 to a body of the chainsaw without removal of the first packaging material 70. In other words, the first packaging material 70 is specifically designed and intended to remain on the bar 30 and chain 20 until the entire bar and chain assembly 60 (formed by the bar 30, chain 20 and first packaging material 70) is installed onto the chainsaw 10. In some cases, the installation may be completed and the drive sprocket cover 40 may also be replaced, and the chain tensioner 42 may also be adjusted so that the chain 20 is taut prior to removal of the first packaging material 70. Alternatively, the first packaging material 70 may be removed prior to adjustment of the chain tensioner 42.

In some embodiments, the first packaging material 70 may include printed information thereon instructing the operator not to remove the first packaging material 70 until installation of the bar and chain assembly 60 is complete. Moreover, in some cases, the first packaging material 70 may include instructions printed thereon to direct the operator as to how to install the bar and chain assembly 60 onto the chainsaw 10. Alternatively or additionally, the first packaging material 70 may include an arrow, text, graphics or other indications to illustrate the proper orientation to be used for installation of the bar and chain assembly 60. In some embodiments, instructions, graphics, or other indications may be printed on the bar 30, and the first packaging material 70 may be transparent so that the instructions, graphics or other indications may be visible to the operator to facilitate assembly.

In some embodiments, the bar and chain assembly 60 may be packaged in connection with second packaging material 80 that may be removed prior to the bar and chain assembly 60 being installed on the chainsaw 10. FIG. 3 illustrates an example of one portion of second packaging material 80 that may be used in connection with one example embodiment. The example of FIG. 3 provides the second packaging material 80 in the form of a cardboard or plastic portion that fits adjacent to the chainsaw body engagement portion 34. It should be noted that the second packaging material 80 of FIG. 3 merely shows a backing portion thereof, and thus a substantially similar sized front portion may be disposed to oppose the backing portion to substantially cover the chainsaw body engagement portion 34 (or substantially all portions of the bar 30 and chain 20 that are not covered by the first packaging material 70). The backing portion and front portion may be affixed to each other, or may be a unitary piece of material that is folded around the front and back portions of the chainsaw body engagement portion 34. In some embodiments, the second packaging material 80 may overlap at least a portion of the first packaging material 70. However, overlap is not required, and indeed may not be present, in all embodiments. In some cases, the second packaging material 80 may be a bag, cardboard insert, or other container into which an entirety or at least a substantial portion of the bar and chain assembly 60 may fit. The second packaging material 80, if employed, may be designed to be removed prior to installation of the bar and chain assembly 60 onto the chainsaw 10. Furthermore, the second packaging material 80 may be provided such that it may be easily removed without interfering with the ability of the first packaging material 70 to continue to hold the bar and chain assembly 60 together.

In an example embodiment, the second packaging material 80 may include a slot engagement tab 82. The slot engagement tab 82 may be an extension of the second packaging material 80 that may extend through the slot 36 to hold the second packaging material 80 in place relative to the bar and chain assembly 60. In some embodiments, the slot engagement tab 82 may include orientation information, instructions or other printed materials to assist the operator in installing the bar and chain assembly 60 onto the chainsaw 10. However, in other embodiments, the slot engagement tab 82 may not include any printed material thereon, and instead, printed material may be provided on the inside or outside of the second packaging material 80. In embodiments in which the printed material is provided on the outside of the second packaging material, instructions may be provided to indicate that the second packaging material 80 is to be removed prior to installation of the bar and chain assembly 60, but the first packaging material 70 is not to be removed until the bar and chain assembly 60 has been installed on the chainsaw 10.

As shown in FIG. 3, the second packaging material 80 may also include a cutout 84 to facilitate hanging of the bar and chain assembly 60 from a retail display rack, a work bench or other hanger prior to sale, use or installation of the bar and chain assembly 60. Thus, not only may the bar and chain assembly 60 be provided for assembly with a new chainsaw when the chainsaw is purchased, but the bar and chain assembly 60 may also be provided as a replacement bar and chain or to upgrade a previous bar and chain.

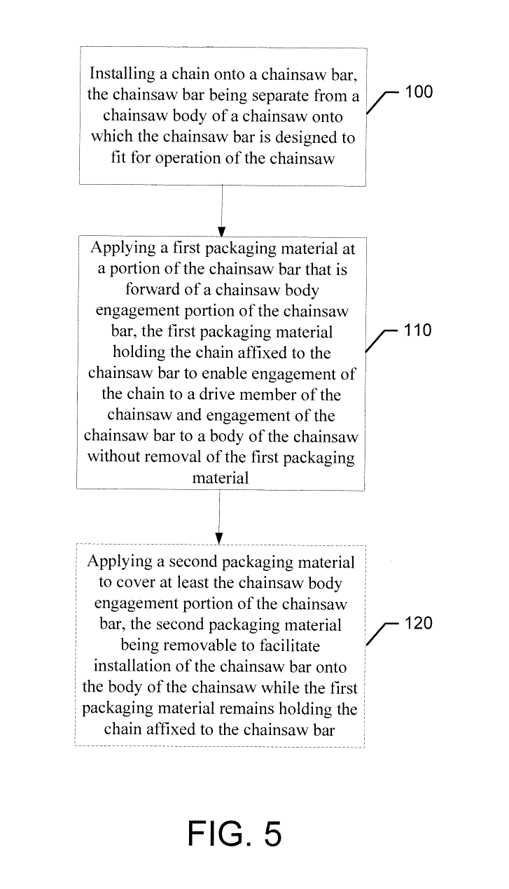

FIGS. 1-4 may be useful in understanding how the bar and chain assembly 60 may be structured, and how the bar and chain assembly 60 may be arranged in connection with installation of the bar and chain assembly 60 onto the chainsaw 10. However, example embodiments may also extend to the method of packaging the bar 30 and chain 20 with the first packaging material 70. FIG. 5 illustrates a method of packaging according to an example embodiment.

As shown in FIG. 5, the method may include installing a chain onto a chainsaw bar at operation 100. The chainsaw bar may be separate from a chainsaw body of a chainsaw onto which the chainsaw bar is designed to fit for operation of the chainsaw when the installation of the chain is performed. The method may further include applying a first packaging material at a portion of the chainsaw bar that is forward of a chainsaw body engagement portion of the chainsaw bar at operation 110. The first packaging material may hold the chain affixed to the chainsaw bar to enable engagement of the chain to a drive sprocket of the chainsaw and may also enable engagement of the chainsaw bar to a body of the chainsaw without removal of the first packaging material. In some embodiments, the method may include an additional operation (which may be optional in some cases) including applying a second packaging material to cover at least the chainsaw body engagement portion of the chainsaw bar at operation 120. The second packaging material may be removable to facilitate installation of the chainsaw bar onto the body of the chainsaw while the first packaging material remains to hold the chain affixed to the chainsaw bar. In some cases, the second packaging material may be applied with instructions for installation of the chainsaw bar onto the body of the chainsaw without removal of the first packaging material. In an example embodiment, applying the first packaging material may include applying a shrink-wrap material to the chainsaw bar with the chain installed thereon. In some embodiments, applying the first packaging material may include applying a thin layer of plastic material (e.g., transparent plastic material) extending at least around both sides of the chainsaw bar and opposing sides of the chain attached thereto at a portion of the chainsaw bar that is proximate to and forward of the chainsaw body engagement portion. In some cases, applying the first packaging material may include applying the first packaging material to all portions of the chainsaw bar that are forward of the chainsaw body engagement portion (e.g., the exposed portions of the bar). In an example embodiment, applying the first packaging material may include applying the first packaging material with instructions for installation of the chainsaw bar and chain onto the chainsaw prior to removal of the first packaging material. In some embodiments, applying the second packaging material may include applying a cardboard covering over the chainsaw body engagement portion of the chainsaw bar. In some cases, applying the cardboard covering may include applying the cardboard covering having a slot engagement tab disposed thereon where the slot engagement tab is provided through a slot in the chainsaw body engagement portion of the chainsaw bar. In an example embodiment, the slot engagement tab may include an indication of which portion of the chainsaw bar is oriented upward for installation thereof.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A method comprising:
installing a chain onto a chainsaw bar, the chainsaw bar being separate from a chainsaw body of a chainsaw onto which the chainsaw bar is designed to fit for operation of the chainsaw; and
applying a first packaging material at a portion of the chainsaw bar that is forward of a chainsaw body engagement portion of the chainsaw bar prior to installation of the chainsaw bar to the chainsaw body, the first packaging material holding the chain affixed to the chainsaw bar to enable engagement of the chain to a drive member of the chainsaw and engagement of the chainsaw bar to a body of the chainsaw without removal of the first packaging material.

2. The method of claim 1, further comprising applying a second packaging material to cover at least partially the chainsaw body engagement portion of the chainsaw bar, the second packaging material being removable to facilitate installation of the chainsaw bar onto the body of the chainsaw while the first packaging material remains holding the chain affixed to the chainsaw bar.

3. The method of claim 2, further comprising applying the second packaging material with instructions for installation of the chainsaw bar onto the body of the chainsaw without removal of the first packaging material.

4. The method of claim 1, wherein applying the first packaging material comprises applying a thin layer of plastic material extending at least around both sides of the chainsaw bar and corresponding portions of the chain adjacent thereto at a portion of the chainsaw bar that is proximate to and forward of the chainsaw body engagement portion.

5. The method of claim 1, wherein applying the first packaging material comprises applying a shrink-wrap material to the chainsaw bar with the chain installed thereon.

6. The method of claim 1, wherein applying the first packaging material comprises applying the first packaging material to all portions of the chainsaw bar that are forward of the chainsaw body engagement portion.

7. The method of claim 1, wherein applying the first packaging material comprises applying the first packaging material with instructions for installation of the chainsaw bar and chain onto the chainsaw without removal of the first packaging material.

8. The method of claim 2, wherein applying the second packaging material comprises applying a cardboard covering over the chainsaw body engagement portion of the chainsaw bar.

9. The method of claim 8, wherein applying the cardboard covering comprises applying the cardboard covering having a slot engagement tab disposed thereon, the slot engagement tab being provided through a slot in the chainsaw body engagement portion of the chainsaw bar.

10. The method of claim 9, wherein the slot engagement tab includes an indication of which portion of the chainsaw bar is oriented upward for installation thereof.

11. The method of claim 1, further comprising removing the first packaging material after engagement of the chain to the drive member of the chainsaw and engagement of the chainsaw bar to the body of the chainsaw.

12. A prepackaged chainsaw bar assembly comprising:
a chainsaw bar having a chainsaw body engagement portion configured to engage a body of a chainsaw proximate to a drive member of the chainsaw;
a chain for operable engagement with the chainsaw bar; and
a first packaging material applied at a portion of the chainsaw bar that is forward of the chainsaw body engagement portion prior to installation of the chainsaw bar to the body of the chainsaw, the first packaging material holding the chain affixed to the chainsaw bar to enable engagement of the chain to the drive member of the chainsaw and engagement of the chainsaw bar to the body of the chainsaw without removal of the first packaging material.

13. The prepackaged chainsaw bar assembly of claim 12, further comprising a second packaging material applied to cover at least partially the chainsaw body engagement portion of the chainsaw bar, the second packaging material being removable to facilitate installation of the chainsaw bar onto the body of the chainsaw while the first packaging material remains holding the chain affixed to the chainsaw bar.

14. The prepackaged chainsaw bar assembly of claim 13, wherein the second packaging material includes instructions printed thereon providing directions for installation of the chainsaw bar onto the body of the chainsaw without removal of the first packaging material.

15. The prepackaged chainsaw bar assembly of claim 12, wherein the first packaging material comprises a thin layer of plastic material applied to extend at least around both sides of the chainsaw bar and corresponding portions of the chain adjacent thereto at a portion of the chainsaw bar that is proximate to and forward of the chainsaw body engagement portion.

16. The prepackaged chainsaw bar assembly of claim 12, wherein the first packaging material comprises a shrink-wrap material.

17. The prepackaged chainsaw bar assembly of claim 12, wherein the first packaging material is applied to an exposed portion of the chainsaw bar comprising all portions of the chainsaw bar that are forward of the chainsaw body engagement portion.

18. The prepackaged chainsaw bar assembly of claim 12, wherein the first packaging material is provided with instructions printed thereon for installation of the chainsaw bar and chain onto the chainsaw without removal of the first packaging material.

19. The prepackaged chainsaw bar assembly of claim 13, wherein the second packaging material comprises a cardboard covering over at least the chainsaw body engagement portion of the chainsaw bar.

20. The prepackaged chainsaw bar assembly of claim 19, wherein the cardboard covering comprises a slot engagement tab disposed thereon, the slot engagement tab being provided through a slot in the chainsaw body engagement portion of the chainsaw bar.

21. The prepackaged chainsaw bar assembly of claim 20, wherein the slot engagement tab includes an indication of which portion of the chainsaw bar is oriented upward for installation thereof.

22. The prepackaged chainsaw bar assembly of claim 12, wherein the first packaging material is removed after engagement of the chain to the drive member of the chainsaw and engagement of the chainsaw bar to the body of the chainsaw.
